(19) United States
(12) Patent Application Publication
(10) Pub. No.: US 2006/0249981 A1
(43) Pub. Date: Nov. 9, 2006

(54) Liftgate for a motor vehicle

(75) Inventors: Gerd Heuel, Olpe (DE); Peter Tillmann, Plettenberg (DE); Dirk Rau, Finnentrop (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Dura Automotive Plettenberg Entwicklungs-und Vertriebs GmbH

(21) Appl. No.: 11/431,798

(22) Filed: May 9, 2006

(30) Foreign Application Priority Data
May 9, 2005 (DE) 10 2005 021 306.5

(51) Int. Cl. B60J 5/10

(52) U.S. Cl. 296/146.8; 296/106

(57) ABSTRACT

An improved liftgate for a vehicle, in particular for a motor vehicle, comprises an upper gate, which at the top is pivotally connectable with the vehicle, and a lower gate, which at the bottom is pivotally and releasably connectable with the vehicle. The bottom of the upper gate is releasable connectable with the top of the lower gate.

### CROSS-REFERENCE TO RELATED APPLICATIONS

This application claims priority to German Patent Application Serial No. 10 2005 021 306.5 filed May 9, 2005, which is hereby incorporated by reference in its entirety for all purposes.

### FIELD

The present disclosure relates to a liftgate for a vehicle, in particular for a motor vehicle.

### BACKGROUND AND SUMMARY

From DE 196 35 873 C2 a liftgate for a motor vehicle is known, which at the top is pivotally connected with the motor vehicle.

Furthermore, liftgates for motor vehicles are known, which comprise an upper gate and a lower gate, the upper gate being pivotally connected with the motor vehicle at the top, and the lower gate at the bottom. When the upper gate is open, the lower gate can be opened as well.

It is the object underlying the present disclosure to propose a liftgate for a vehicle, in particular for a motor vehicle, which can be opened in a more versatile way.

In accordance with the present disclosure, this object is solved by a liftgate comprising an upper gate, which at the top is pivotally connected or connectable with the vehicle, and a lower gate, which at the bottom is pivotally connected or connectable with the vehicle. The bottom of the upper gate is releasably connectable with the top of the lower gate. Furthermore, the bottom of the lower gate is releasably connectable with the vehicle.

When the bottom of the upper gate is connected with the top of the lower gate, and when the bottom of the lower gate is released from the vehicle, the upper gate and the lower gate form a single liftgate, which at the top is pivotally connected with the vehicle and can be opened as a whole by a swivel movement.

When the bottom of the upper gate is released from the top of the lower gate, and when the lower gate is pivotally connected with the vehicle at the bottom, the upper gate and the lower gate each can be swivelled separately.

As a result, there is created a three-way liftgate for a vehicle, in particular for a motor vehicle, which can be opened as a whole, but can also be opened separately in upward and downward direction.

The gates can be releasably lockable by means of shaft locks.

Advantageously, the lower gate is releasably lockable with the vehicle on one side or on both sides.

In accordance with another advantageous embodiment, the upper gate and/or the lower gate comprise a frame structure.

Preferably, the frame structures comprise pressed metal parts and/or hollow metal sections. The frame structures can consist of pressed metal parts and/or hollow metal sections. The metal preferably is light metal alloy, in particular an aluminum alloy.

Another advantageous embodiment is characterized in that the gates, in particular the frame structures, are joined by one or more welds.

Instead or in addition, the gates or the frame structures can be bonded by means of a structural adhesive.

Advantageously, one or both gates, in particular one or both frame structures, have a preferably integrally molded beading flange. The integrally molded beading flange can in particular be provided on a hollow section of the lower gate. At the beading flange, the preferably metallic outer skin can be beaded.

Another advantageous embodiment is characterized in that one or both gates, in particular one or both frame structures, have a preferably integrally molded adhesive flange. The adhesive flange preferably is provided on a hollow section of the upper gate. The rear window can be bonded onto the adhesive flange.

In accordance with another advantageous embodiment, the upper gate comprises an upper reinforcing member. Preferably, this is a pressed metallic part. To the upper reinforcing member, in particular an upper, preferably metallic, spoiler cover can be attached.

The present disclosure furthermore relates to a vehicle, in particular a motor vehicle, which is characterized by a liftgate in accordance with the present disclosure.

An embodiment of the present disclosure will subsequently be explained in detail with reference to the accompanying drawings, in which:

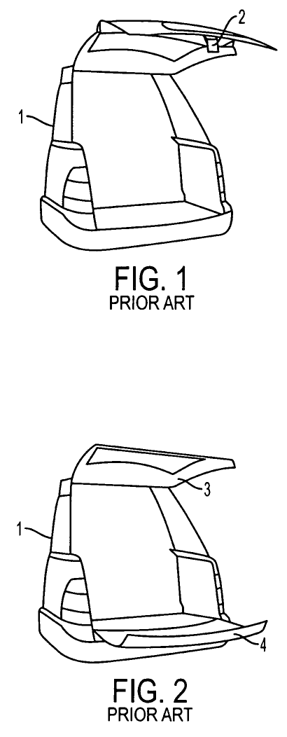

FIG. 1 shows a perspective view of a prior art liftgate, which at the top is pivotally connected with a motor vehicle;

FIG. 2 shows a perspective view of a prior art liftgate, which comprises an upper gate and a lower gate;

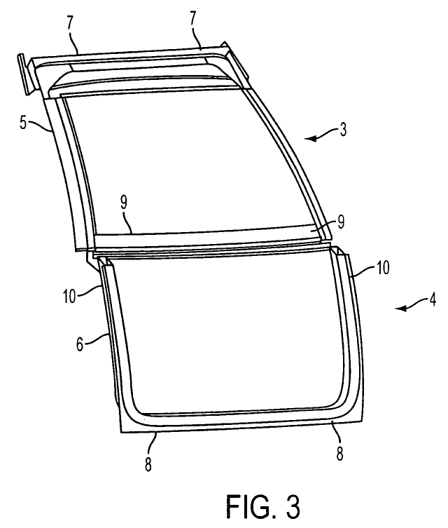

FIG. 3 shows an embodiment of the invention in a perspective view;

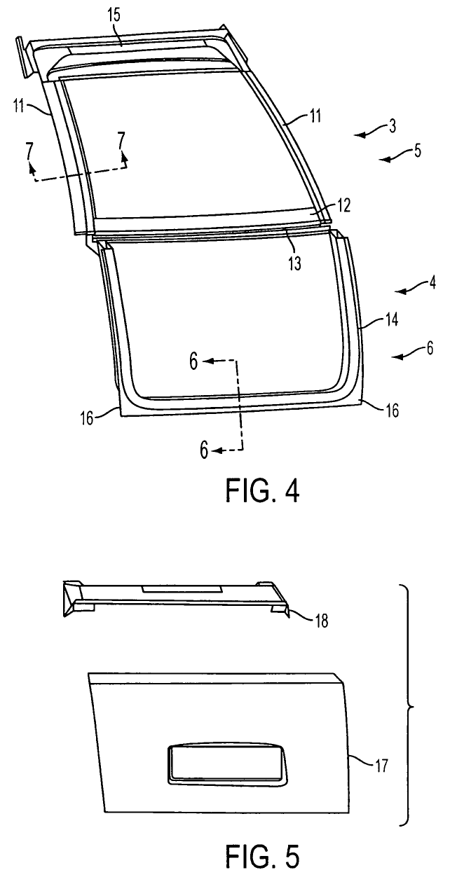

FIG. 4 shows the liftgate of FIG. 3 in an enlarged representation;

FIG. 5 shows an upper metallic spoiler cover and a metallic outer skin;

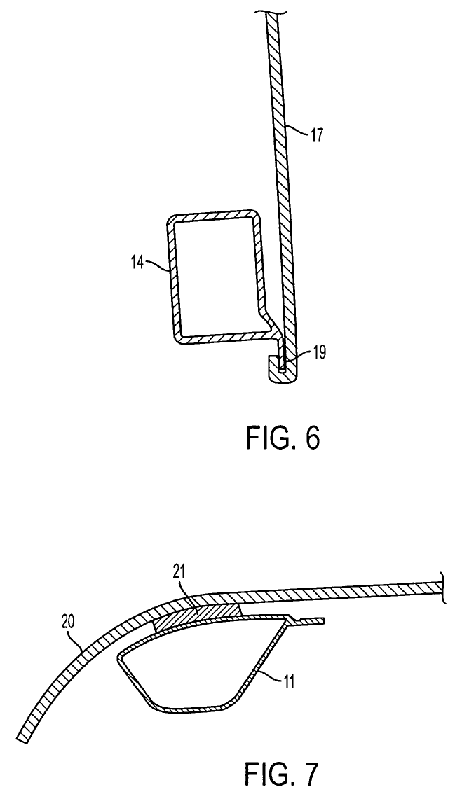

FIG. 6 shows a section along line 6-6 of FIG. 4; and

FIG. 7 shows a section along line 7-7 of FIG. 4.

### DETAILED DESCRIPTION

FIG. 1 shows a known liftgate 2, which in the upper region of the roof is attached to the body 1 of a motor vehicle by means of hinges and which can be opened in upward direction via the axis of rotation of the hinges.

FIG. 2 shows another known liftgate for a motor vehicle, which is centrally divided. The upper gate 3 can be opened in upward direction, and the lower gate 4 can be opened in downward direction.

The liftgate of the present application as shown in FIGS. 3 to 7 comprises an upper gate 3, which at the top is attached to the body 1 in the upper region of the roof by means of rotary hinges 7 and is pivotally connected with the vehicle, and a lower gate 4, which at the bottom is attached to the body 1 by means of hinge locks 8 and is pivotally connected with the vehicle. Furthermore, the bottom of the lower gate 4 can be released from the vehicle. For this purpose, the hinge locks 8 are designed such that they provide for a release of the lower gate 4 from the body 1 and hence from the vehicle. Finally, the bottom of the upper gate 3 is releasably connectable with the top of the lower gate 4.

FIG. 3 shows the closed position. Here, the bottom of the upper gate 3 is connected with top of the lower gate 4. Furthermore, the bottom of the lower gate 4 is connected with the vehicle.

When the liftgate should be opened as a whole, the connection between the bottom of the upper gate 3 and the top of the lower gate 4, as shown in FIG. 3, is maintained. The connection between the bottom of the lower gate 4 and the vehicle is separated. The entire liftgate, consisting of the upper gate 3 and the lower gate 4, which are connected with each other, can then be swivelled upwards about the rotary hinges 7 and be opened. As a result, an opening is achieved as shown in FIG. 1.

When the parts of the liftgate should be opened, the pivotal connection of the bottom of the lower gate 4 with the vehicle is maintained. The connection between the bottom of the upper gate 3 and the top of the lower gate 4 is separated. Then, the upper gate 3 can be swivelled upwards about the rotary hinges 7 and be opened, and the lower gate 4 can be swivelled downwards about the hinge locks 8 and be opened. As a result, the position shown in FIG. 2 is reached. By means of the present disclosure, the two known opening variants as shown in FIGS. 1 and 2 can be realized. In addition to the known opening variants, the present disclosure combines the two variants to a single variant in the form of a three-way liftgate.

The upper gate 3 comprises a frame structure 5. The upper liftgate frame formed by the frame structure 5 is attached to the body 1 in the upper region of the roof by means of the rotary hinges 7.

The lower gate 4 comprises a frame structure 6. The lower liftgate frame formed by the frame structure 6 is releasably attached to the body 1 via the hinge locks 8. The hinge locks 8 provide for a swivel movement of the lower liftgate frame 6.

The two liftgate frames 5, 6 are releasably connected in the vicinity of the shaft by means of shaft locks 9. Furthermore, the lower liftgate frame 6 laterally is releasably connected, i.e. releasably locked, with the body 1 via locks 10.

As shown in FIG. 4, the upper liftgate frame 5 consists of a frame structure which comprises a pressed metal part 15 at the top and hollow metal sections 11, 12 at the sides and at the bottom. The pressed metal parts 15 and hollow metal sections 11, 12 are made of a light metal alloy, in this case aluminum.

The lower liftgate frame 6 consists of a frame structure which comprises pressed metal parts 16 at the lower comers and hollow metal sections 13, 14. The hollow metal section 13 is provided at the top. The hollow metal section 14 is bent to have a U-shape and forms the sides and the bottom. The pressed metal parts 16 and hollow metal sections 13, 14 are made of a light metal alloy, in this case aluminum.

The liftgate frames 5, 6 are joined by a welding process.

As can in particular be taken from FIG. 6, the hollow section 14 of the lower liftgate frame 6 has an integrally molded beading flange 19, at which the metallic outer skin 17, which in this case is made of aluminum, can be beaded.

As can be taken from FIG. 7, the hollow section 11 of the upper liftgate frame 5 includes an integrally molded adhesive flange 21 to which the rear window 20 can be bonded.

The upper reinforcing member 15 of the upper liftgate frame 5 consists of a pressed metallic part 15, in this case aluminum, to which the upper metallic spoiler cover 18, which is shown in FIG. 5 and in this case is made of aluminum, can be attached. Instead or in addition, further functional elements can be mounted at the upper reinforcing member 15, for instance a GPS antenna, wipers, brake lights and the like.

As explained, the frame structures 5, 6 advantageously are made of extruded light metal hollow sections 11, 12, 13, 14, preferably of aluminum, and of pressed light metal parts 15, 16, likewise preferably of aluminum. However, it is also possible that the frame structures 5, 6 consist of roll-profiled hollow sections 11, 12, 13, 14, preferably made of steel, and of pressed parts 15, 16, preferably made of steel. The frame structures 5, 6 can be joined by means of a welding process. However, it is also possible that the frame structures 5, 6 are bonded by means of a structural adhesive. The lower frame structure 6 preferably has an outer skin 17 made of light metal, preferably of aluminum. The upper frame structure 5 preferably has a spoiler cover 18 made of light metal, preferably of aluminum. However, it is also possible that the lower frame structure 6 has an outer skin 17 made of plastics and/or the upper frame structure 5 has a spoiler cover 18 made of plastics.

Onto the upper frame structure 5 an automotive glazing 20 can be adhered. At the upper frame reinforcement 15 and/or at the spoiler cover 18 further functional elements can be mounted, such as a GPS antenna, wipers, brake lights and the like.

1. A liftgate for a vehicle, comprising an upper gate having a top and bottom, which at the top is pivotally connectable with the vehicle, and
a lower gate having a top and bottom, which at the bottom is pivotally and releasably connectable with the vehicle, the bottom of the upper gate being releasably connectable with the top of the lower gate.

2. The liftgate as claimed in claim 1, wherein the upper and lower gates are releasably lockable by shaft locks.

3. The liftgate as claimed in claim 1, wherein the lower gate is releasably lockable with the vehicle on one or both sides.

4. The liftgate as claimed in claim 1, wherein the upper gate and/or the lower gate comprise a frame structure.

5. The liftgate as claimed in claim 4, wherein the frame structure comprises pressed metal parts and/or hollow metal sections.

6. The liftgate as claimed in claim 1, wherein the upper and lower gates are each joined by one or more welds.

7. The liftgate as claimed in claim 6, wherein the upper and lower gates each comprise frame structures and the frame structure are each joined by one or more welds.

8. The liftgate as claimed in claim 7, wherein the frame structures forming the gates are bonded by a structural adhesive.

9. The liftgate as claimed in claim 1, wherein frame structures of one or both of the upper and lower gates have an integrally molded beading flange.

10. The liftgate as claimed in claim 1, wherein frame structures of one or both of the upper and lower gates have an integrally molded adhesive flange.

11. The liftgate as claimed in claim 1, wherein the upper gate comprises an upper reinforcing member.

12. A motor vehicle, comprising:
a three-way rear liftgate having at least a first configuration and a second configuration, the liftgate having at least an upper gate having at least a top region and a bottom region, the upper gate being pivotally connectable with the vehicle at the top region, and a lower gate having at least a top region and a bottom region, the lower gate being pivotally and releasably connectable with the vehicle, and the bottom region of the upper gate being releasably connectable with the top region of the lower gate,
where in the first configuration the bottom of the upper gate is connected with the top of the lower gate, and when the bottom of the lower gate is released from the vehicle, the upper gate and the lower gate move as a single liftgate about the top of the upper gate via a swivel movement, and
where in the second configuration the bottom of the upper gate is released from the top of the lower gate, and when the lower gate is pivotally connected with the vehicle at the bottom, the upper gate and the lower gate each swivel separately in an upward and downward direction.

13. The vehicle as claimed in claim 12, further comprising a shaft lock coupled between the upper and lower gates, said shaft lock releasably locking the upper and lower gates.

14. The vehicle as claimed in claim 13, wherein the lower gate is releasably lockable with the vehicle.

15. The vehicle as claimed in claim 12, wherein the upper gate further includes a frame structure, and the lower gate further includes a frame structure.

16. The vehicle as claimed in claim 15, wherein each of the frame structures comprise pressed metal parts and/or hollow metal sections.

17. The vehicle as claimed in claim 16, wherein each of the frame structures have an integrally molded beading flange.

18. The vehicle as claimed in claim 17, wherein the upper gate comprises an upper reinforcing member.

19. A rear liftgate for a motor vehicle, comprising:
at least an upper gate having at least a top region and a bottom region, the upper gate being pivotally connectable with the vehicle at the top region;
a lower gate having at least a top region and a bottom region, the lower gate section being pivotally and releasably connectable with the vehicle, and the bottom region of the upper gate being releasably connectable with the top region of the lower gate; and
a shaft lock for releasably locking the upper and lower gates.

20. The liftgate as claimed in claim 19, wherein the lower gate is releasably lockable with the vehicle.
